(19) United States
(12) Patent Application Publication
(10) Pub. No.: US 2005/0077066 A1
(43) Pub. Date: Apr. 14, 2005

(54) High speed data cable having individually shielded twisted pairs

(76) Inventor: Jason A. Stipes, Richmond, IN (US)

Correspondence Address: Robert F. I. Conte;LEE, MANN, SMITH, MCWILLIAMS, SWEENEY & OHLSON, P.O. Box 2786, Chicago, IL, 60690-2786, US

(21) Appl. No.: 10/869,805

(22) Filed: Jun. 16, 2004

Related U.S. Application Data
(63) Continuation of application No. 09/885,086, filed on Jun. 20, 2001, now abandoned.
Application No. 09/885,086 is a continuation of application No. 09/386,636, filed on Aug. 31, 1999, now abandoned.

(51) Int. Cl. H01B 7/00

(52) U.S. Cl. 174/27

(57) ABSTRACT

A cable having a plurality of individually shielded twisted pairs, ISTPs. Each shield has multiple layers. Each shield has a first surface and a second surface opposite the first surface. Each shield has a first longitudinally extending side and a second longitudinally extending side. Each shield is oriented around its respective twisted pair with a lateral fold or “cigarette wrap” fold. With respect to each shield, a portion of each shield's first longitudinally extending side is bonded to a portion of its second longitudinally extending side. An overall shield, often a braided construction, may surround the plurality of ISTPs. A cable jacket surrounds the overall shield and the plurality of individually shielded twisted pairs.

This is a continuation application of my application Ser. No. 09/386,636 filed Aug. 31, 1999.

### FIELD OF THE INVENTION

The present invention relates to a data cable with individually shielded twisted pairs.

### BACKGROUND

Electronic cables provide a highway through which much of today's digital information travels. Many of the cables which transmit digital information utilize a plurality of twisted pairs. These twisted pair cables, to satisfy high-speed digital requirements, need to transmit information at high frequencies. Unfortunately, high frequencies, generally transmitted at extremely low voltages, are susceptible to electronic interference. For instance, near end cross talk between twisted pairs within the same cable, referred to in the industry as NEXT, can interfere with high frequency signal transmission.

To control NEXT, industry uses data cables which have individually shielded twisted pairs, ISTP's. Each ISTP consists of a single twisted pair with a foil shield wrapped around the single twisted pair. The foil shield is often wrapped with a lateral or “cigarette wrap” type fold. The phrase lateral fold and cigarette wrap are used herein interchangeably. The lateral fold extends longitudinally along the length of the single twisted pair. Though ISTP's improve a cable's NEXT performance and immunity to other electronic interference, the configuration can cause other cable attributes to be adversely affected. Specifically, the cable's impedance and return loss performance is often degraded by the application of an individual shield around the pair.

An unshielded twisted pair's (UTP) impedance is determined by the size of the metallic conductors used, the dielectric constant of the insulating material, and the center to center spacing of the two conductors. The impedance of an ISTP is influenced by these same factors, but is also influenced by the presence of the shield wrapped around its circumference. Present day shields can suffer from variations in geometry. Very small variations in the geometry and spacing of the overall shield can drastically affect the cable's impedance. The shield, commonly made of a thin metallic foil, can wrinkle, shift, and even open. The unwanted wrinkling, shifting, and opening can occur during manufacturing, installation, and use of the cable. The wrinkling, shifting, and opening can result in a deleterious increase in impedance variation. The increase in variation can affect other cable parameters such as the return loss (RL). The impedance variations and the related degradation of cable performance caused by the conventional ISTP cables are clearly undesirable.

### SUMMARY

The present invention desires to provide a cable having a plurality of individually shielded twisted pairs which have an improved resistance to deformation, and in turn, increased impedance stability over conventionally designed cables. To provide ISTP's with improved resistance to deformation, the invention provides a cable having a plurality of individually shielded twisted pairs. Each individually shielded twisted pair includes a shield comprised of multiple layers with a first surface and a second surface opposite the first surface. The shield has a first longitudinally extending side and a second longitudinally side. The shield is oriented around the twisted pair with a lateral fold or “cigarette wrap” fold. A portion of the laterally wrapped shield is bonded to itself. By bonding a portion of the shield to itself the shield forms a semi-rigid tube which encompasses the twisted pair. As a result of becoming more rigid and securely wrapped, the shield retains its shape and prevents the shield from shifting or opening up during the manufacturing process or during cable use. The bonded shield configuration also offers resistance to wrinkling and deformation of the shield. The result of the improved shield stability is an overall reduction in impedance variation in the cable.

In accordance with the above desire, the high-speed data cable has a plurality of individual twisted pairs. Each individual twisted pair has a first insulated conductor twisted about a second insulated conductor. The cable further has a plurality of shields. Each shield of the plurality is oriented around a different respective one of the plurality of twisted pairs. Each twisted pair is radially within the shield oriented around it, and the twisted pair is oriented within the shield, exclusive of the other plurality of twisted pairs. The cable may also have an overall shield, often of braided construction, which surrounds the plurality of ISTP's. The cable has a jacket which surrounds the overall shield and the plurality of shield's oriented around each twisted pair.

Each of the plurality of shields is oriented with a lateral fold. Each shield has a first longitudinally extending side and a second longitudinally extending side. A first surface forms a surface of both the first and second longitudinally extending sides. A second surface also forms a surface of both said first and second longitudinally extending sides. The first surface is opposite the second surface. A portion of the first longitudinally extending side is bonded to a portion of said second longitudinally extending side.

In one embodiment, the bonded portion includes a portion of the first surface forming the surface of the first longitudinally extending side, and a portion of the second surface forming a portion of the surface of the second longitudinally extending side.

In another embodiment, the bonded portion includes a portion of the first surface forming a surface of the first longitudinally extended side, and a portion of the first surface forming a portion of the second longitudinally extending side.

These and other features of the invention will be apparent to those skilled in the art when the specification is read in conjunction with the drawings. It being expressly understood, however, that the drawings and detailed description are for purposes of illustration only and are not intended as a definition of the limits of the invention.

### BRIEF DESCRIPTION OF DRAWINGS

FIG. 1 shows a lateral sectional view of the cable of the present invention; the cable has four individually shielded twisted pairs.

FIGS. 2a-2e show lateral cross-sectional views of alternative embodiments of an individually shielded twisted pair of the present invention.

FIG. 3a shows a blown-up top and side view of a partially unwrapped shield sectioned along its lateral and longitudinal length.

FIGS. 3b shows a partial lateral sectional view of the alternative embodiment of the individual shielded twisted pairs shown in FIG. 2d.

FIG. 3c shows a partial lateral sectional view of an alternative embodiment of a shielded twisted pair.

FIGS. 4a-4d disclose in block diagram format alternative methods of making the individually shielded twisted pairs of the present invention.

### DETAILED DESCRIPTION

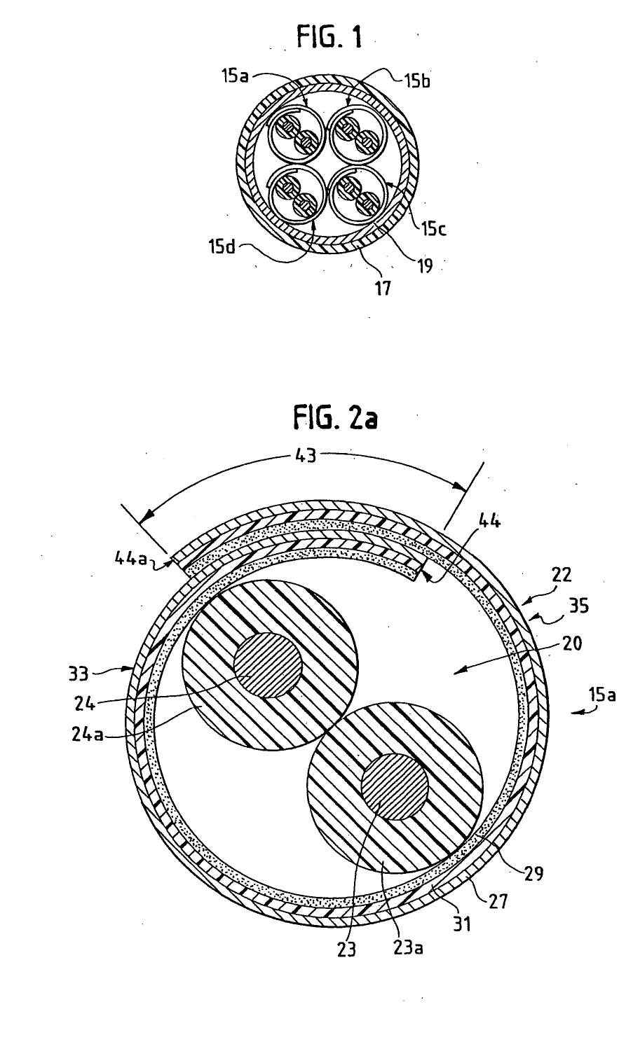

Referring to FIG. 1, we see a cross-sectional view of a data cable having a plurality of individually shielded twisted pairs 15a, 15b, 15c, 15d which are the subject of the present invention. The cable includes a jacket 17. The jacket can be PVC, a fluoropolymer or other types of material. The jacket in the shown construction is about 0.020 inches thick. Disposed radially inward of the jacket is a braided overall metallic shield 19. The braided shield offers between 40% and 65% coverage. Disposed radially inward from the braid are the four individually shielded twisted pairs of the present invention.

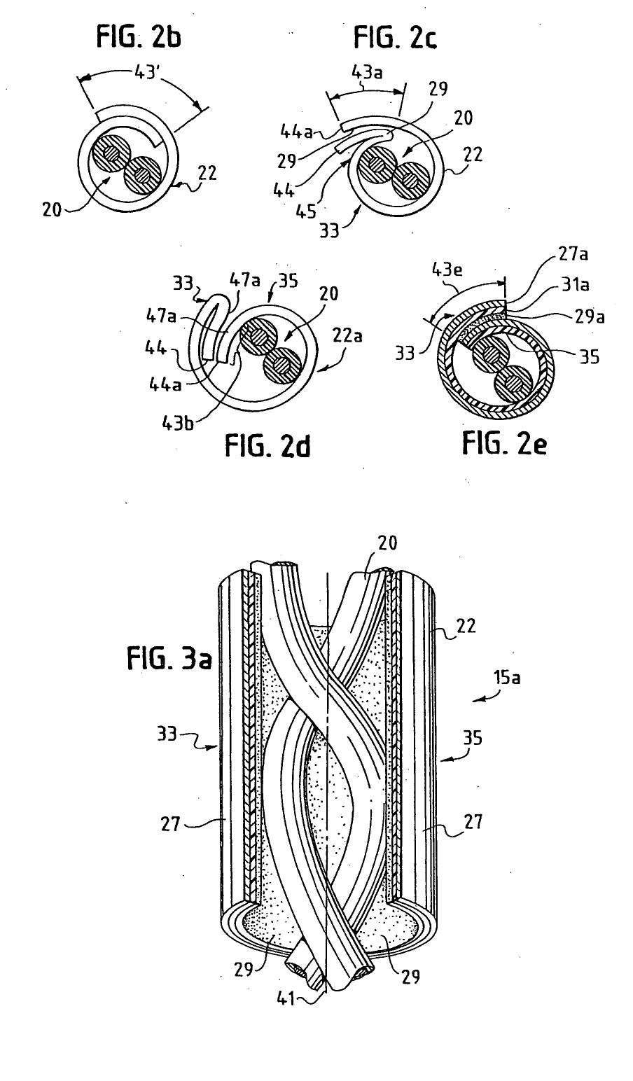

In the shown cable, all of the four individually shielded twisted pairs are the same. FIG. 2a discloses a blow-up of one of the individually shielded twisted pairs 15a shown in FIG. 1. The individually shielded twisted pair 1 Sa has a single twisted pair 20 and a single laterally folded shield 22. The twisted pair has a first conductor 23 surrounded by a first insulation 23a. The twisted pair has a second conductor 24 surrounded by a second insulation 24a. The first insulated conductor 23, 23a and the second insulated conductor 24, 24a are twisted about each other along each conductor's longitudinal length. The first and second insulations can be bonded at the place where the first and second insulations come into contact with each other. The bonding can be by an adhesive. The bonding can be by a common seamless web (not shown). Generally, the first and second insulations are the same. The insulations can be a fluoropolymer or polyolefin such as fluorinated ethylene propylene, polyethylene, or polypropylene. The first and second conductors of the twisted pair are also the same. The disclosed conductors are between 28-22AWG. The conductors can be stranded or solid.

The single shield 22 surrounds the single twisted pair 20. The shield, as shown in FIG. 2a has at least three distinct layers. A first layer 27, which forms a first surface, is made of aluminum. The layer is generally between 0.0003-0.003 inches. The second layer 29, which forms a second surface, is comprised of ethylene acrylic acid copolymer, EAA. The EAA is between 0.0003-0.001 inches thick. The EAA is used as an adhesive layer. A third layer 31 polyester is between the first and second layer. The third layer 31 is between 0.0003-0.001 inches. The third layer 31 is the strength layer for the shield or tape. Although a specific shielding tape, having a specific adhesive, has been shown, other tapes with other adhesives could be used. For instance, the first layer could be copper, silver or other conductive metal; the second layer, the adhesive layer, could be any of several copolymers or polyolefins such as EBA, EVA, EVS, EVSBA or even LDPE. The third layer could be a fluoropolymer or polyolefin such as polyester, polypropylene or polyethylene.

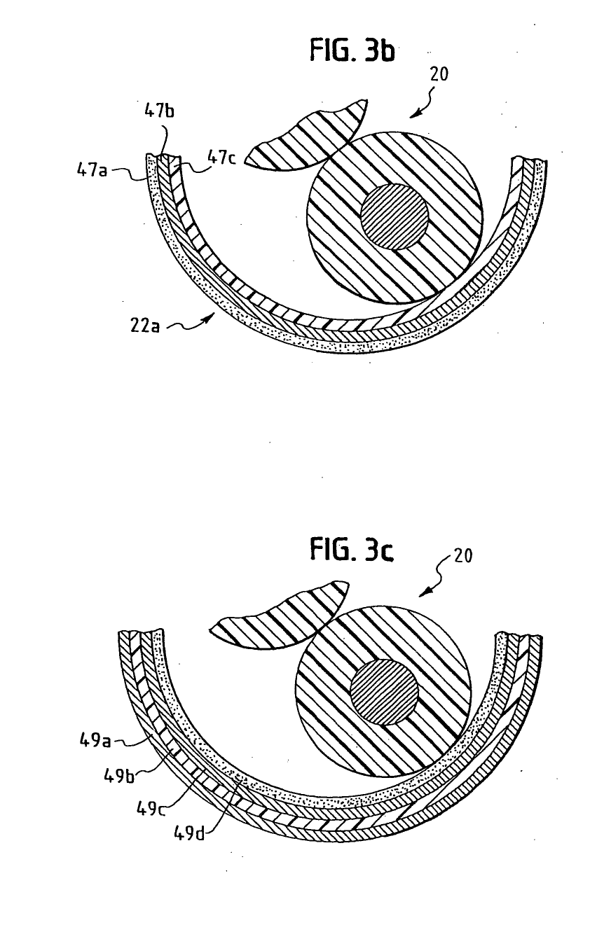

The shield 22, as shown in FIG. 3a has a first longitudinally extending side 33 and a second longitudinally extending side 35. The first and second sides extend the entire length of the shield's longitudinal axis 41. The first and second longitudinally extending sides are adjacent and divided by the shield's longitudinal axis 41. The second surface 29 forms a surface of both the first and second longitudinally extending sides. The first surface 27 also forms a surface of both the first and second longitudinally extending sides. Returning to FIG. 2a, the shield 22 is oriented around the twisted pair 20 with a lateral or “cigarette wrap” fold. The phrases “lateral fold” and “cigarette wrap” are used herein interchangeably. The phrases include without limitation, a shield which is formed by primarily folding the shield along the shield's lateral width, rather than along the shield's longitudinal length 41. The geometry of the tape when folded along its lateral width around the twisted pair forms an overlapping portion 43 which runs along the longitudinal length of the twisted pair. This overlapping portion 43 runs parallel with the longitudinal axis of the twisted pair and does not spiral along the longitudinal axis of the pair if the cable consisting of a plurality of ISTP's is cabled (bunched) together by a planetary action. A planetary action means that no torque forces are experienced by the plurality of ISTP's as they are twisted together. The overlapping portion 43 will run parallel with the longitudinal axis of the twisted pair and will also spiral around the longitudinal axis of the twisted pair if the cable consisting of a plurality of ISTP's is cabled together using a conventional single or double twist action. Single or double twist cabling action means that torque is induced in the individual ISTP's during the process of twisting the plurality of ISTP's together. Both methods are commonly used in the cable making industry and either may be used in the manufacturing process of the present invention.

In the area of the shield's overlapping portion 43, the second surface 29 faces the first surface 27. A first longitudinally extending edge 44 faces a clock-wise direction; a second longitudinal edge 44a faces a counter-clockwise direction. In the area of the overlapping portion 43, the portion of the second surface 29 which forms a surface of the second longitudinally extending side is bonded to the portion of the first surface 27 which forms a surface of the first longitudinally extending side. The arcuate length of the overlapping portion 43 can vary. FIG. 2b shows an overlapping portion with a larger arcuate length than the overlapping portion 43 shown in FIG. 2a

It should be noted that although FIG. 2a discloses a shield were the radially outward layer is the aluminum layer. The shield could have many different constructions. For instance, the aluminum layer could be in between the EAA and the polyester layer. In this construction, the EAA layer would be the radially most outward layer. Alternatively, the polyester layer could be the most radially outward layer. The EAA layer, radially inward, and the aluminum layer, in between. The overlapping portion can have the second side radially outward of the first side as shown in FIG. 2a or the second side radially inward of the first side. Still other orientations, some of which are discussed below, could be used.

FIG. 2c shows an alternative embodiment of an individual shielded twisted pair. The individually shielded twisted pair utilizes a twisted pair and a shield which are the same as the twisted pair and shield shown in FIG. 2a. The laterally folded shield 22 in FIG. 2c, however, has a different orientation than the laterally folded shield in FIG. 2a. In FIG. 2c, the first longitudinally extending edge 44 does not overlap the second longitudinally extending edge 44a. Rather, the shield 22 is laterally folded along its longitudinal length to orient the first longitudinally extending edge 44 laterally close the second longitudinally extending edge 44a. The shield is laterally folded to contact the second surface 29 of the first longitudinally extending side 33 with the second surface 29 of the second longitudinally extending side 35. The contacted surfaces are bonded together. The bonded portion 43a is then laterally folded over an adjacent portion 45 of the shield.

FIG. 2d shows yet another embodiment of an individually shielded twisted pair. The embodiment in FIG. 2d is the same as FIG. 2a except for the construction of the shield and the orientation of the wrapped shield. As shown in FIG. 3b, the shield 22a has a first layer 47a which is EAA, the second layer 47b, is aluminum and the third layer 47c, is polyester. Returning to FIG. 2d, in this configuration, the longitudinally extending edges do not overlap. The shield is laterally folded to contact the first layer 47a of the first longitudinally extending side 33 with the first layer 47a of the second longitudinally extending side 35. The contacted layers are then bonded. The bonded portion 43b is then folded radially inward of an adjacent portion of the shield 45a.

FIG. 3c shows an alternative to the shield construction shown in FIGS. 3a and 3b. The shield has a first aluminum layer 49a, a second polyester layer 49b, a third aluminum layer 49c and a fourth EAA layer 49d.

FIG. 2e shows still a further embodiment of the shield's construction, The EAA layer 29a does not form a surface which covers the first 33 and second 35 longitudinally extending sides. It rather only covers a portion 43e of the second longitudinally extending side. It only covers the portion 43e of the second side 35 bonded to the first side 33. The aluminum layer, at portion 43e, is between the EAA layer 29a and the polyester layer 31a. The first and second longitudinally extending sides include both the aluminum layer and the polyester layer.

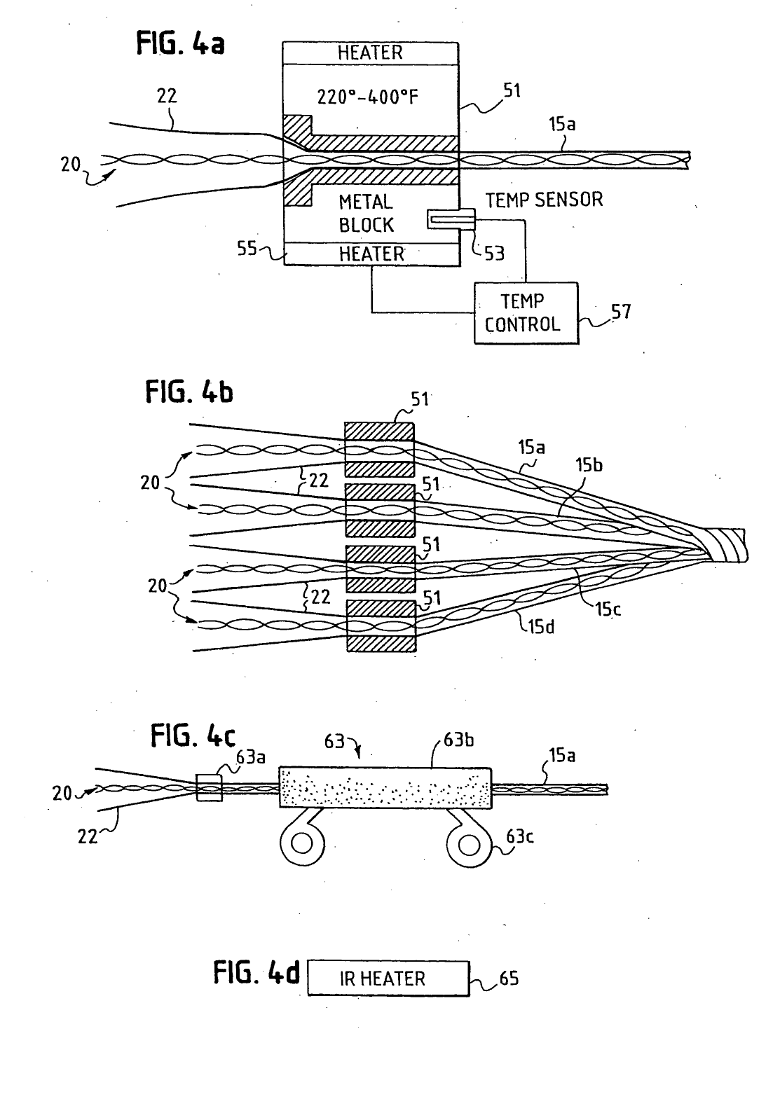

Referring to FIG. 4a, we see a block diagram disclosing an apparatus to make the individually shielded twisted pairs of the present invention. The single twisted pair 20 simultaneously with the shield is passed through a metal forming/heating block 51. The metal forming block laterally wraps the shield around the twisted pair and bonds the shield to form ISTP 15a. The metal forming/heating block is heated between 220 F-400 F to accomplish the bonding. Connected to the metal forming block is a temperature sensor 53 and a heater 55. A control 57 is interfaced with the heater and temperature sensor. The twisted pair and shield is conveyed through the heated forming block by the pulling tension generated by an additional piece of cable manufacturing equipment such as the capstan from an extrusion line or cabler.

As a further alternative method, as shown in FIG. 4b, a plurality of ISTP's can be twisted about each other into a complete cable concurrently with a plurality of the metal forming/heating blocks 51.

An alternative method of forming the individual shielded twisted pairs is shown in FIG. 4c. In the alternative method, a hot pellet box 63 is used to bond the shield to itself. The alternative apparatus has a first section 63a which laterally folds the shield around the twisted pair. The shield, in the second portion 63b of the apparatus, is bonded to itself with the hot pellets. The pellets are heated with a hot air heater 63c.

Rather than utilizing hot air or an electrical heating element, each of the described apparatuses could use an infrared heater 65 (FIG. 4d).

Other embodiments of the present invention as well as mechanical equivalents will be apparent to those skilled in the art and it is not the intention of the specification to limit the scope of the invention, but rather to provide an example of an embodiment of the invention.

1. A high speed data cable comprising:
a plurality of individual twisted pairs, each individual twisted pair includes a first insulated conductor twisted about a second insulated conductor;
a jacket surrounding said plurality of individual twisted pairs,
at least two of said twisted pairs each being laterally wrapped with a metal composite shield having a polymer layer and a metal layer, and said metal layer having a thickness of from about 0.0003 inches to 0.001 inches,
each of said shields has an inner surface and an outer surface opposite the inner surface and said outer surface facing said jacket,
each shield has a first overlapping longitudinal side and a second overlapping longitudinal side, and
said first and second overlapping sides being bonded together by a bonding agent and wherein said bonding agent and each of said shield provide improved resistance to deformation and impedance stability.

2. The high speed data cable of claim 1 wherein said longitudinal side is folded over so that the outer surface contacts itself to provide a second longitudinal side fold, and
wherein the inner surface of said first longitudinal side is bonded to said second longitudinal side fold.

3. The high speed data cable of claim 1 wherein said first longitudinal side is folded over so that the inner surface contacts itself to provide a first longitudinal side fold, and
wherein the outer surface of said second longitudinal side is bonded to said first longitudinal side fold.

4. The high speed data cable of claim 1 wherein each of the metal shields comprises:
a first layer of aluminum having a thickness of 0.0003 to 0.001 inches a second layer of aluminum having a thickness of 0.0003 to 0.001 inches and a polymer layer between said first and second layer of aluminum.

5. The high speed data cable of claim 2 wherein each of the metal shields comprises:
a first layer of aluminum having a thickness of 0.0003 to 0.001 inches, a second layer of aluminum having a thickness of 0.0003 to 0.001 inches, and a polymer layer between said first and second layer of aluminum.

6. The high speed data cable of claim 3 wherein each of the metal shields comprises:
a first layer of aluminum having a thickness of 0.0003 to 0.001 inches, a second layer of aluminum having a thickness of 0.0003 to 0.001 inches, and a polymer layer between said first and second layer of aluminum.

7. The high speed data cable of claim 1 wherein only one of the overlapping longitudinal sides has said bonding agent thereon.

8. The high speed data cable of claim 4 wherein only one of the overlapping longitudinal sides has said bonding agent thereon.

9. The high speed data cable of claim 5 wherein only one of the overlapping longitudinal sides has said bonding agent thereon.

10. The high speed data cable of claim 6 wherein only one of the overlapping longitudinal sides has said bonding agent thereon.
